(19) United States
(12) Patent Application Publication
(10) Pub. No.: US 2015/0154048 A1
(43) Pub. Date: Jun. 4, 2015

(54) MANAGING WORKLOAD TO PROVIDE MORE UNIFORM WEAR AMONG COMPONENTS WITHIN A COMPUTER CLUSTER

(71) Applicant: International Business Machines Corporation, Armonk, NY (US)

(72) Inventors: Shareef F. Alshinnawi, Durham, NC (US); Gary D. Cudak, Creedmoor, NC (US); Edward S. Suffern, Chapel Hill, NC (US); J. Mark Weber, Wake Forest, NC (US)

(73) Assignee: International Business Machines Corporation, Armonk, NY (US)

(21) Appl. No.: 14/096,602

(22) Filed: Dec. 4, 2013

(51) Int. Cl. G06F 9/48; G06F 1/32

(52) U.S. Cl. CPC G06F 9/4881; G06F 1/3287; G06F 9/4856

(57) ABSTRACT

A method and a computer program product for implementing the method are provided for wear leveling the physical servers or other components within a cluster. The method includes identifying uptime for each of a plurality of physical servers within a cluster and scheduling jobs on the physical servers within the cluster giving priority to the use of physical servers in order of increasing uptime. The physical servers within the cluster that have no assigned jobs are then powered off. As a result, physical servers having low uptime relative to other physical servers within the cluster will operate more so that their uptime increases, and physical servers having high uptime relative to other physical servers within the cluster will operate less so that their uptime does not increase. Over time, the method will narrow the range of uptime, which may be referred to as “wear leveling.”

### BACKGROUND

1. Field of the Invention

The present invention relates to management of workload across physical servers or other components within in a cluster.

2. Background of the Related Art

A computer cluster provides components such as servers, network switches and data storage devices that communicate with each other using a high speed local area network. A single cluster may include just a few of these components or into the thousands of components. However, the components of a cluster work together in a coordinated manner to provide greater performance than an equal number of components operating on their own.

Such a cluster may implement a cloud computing environment in which a job is assigned to a virtual machine somewhere in the computing cloud. The virtual machine provides the software operating system and has access to physical resources of the cluster, such as input/output bandwidth, processing power and memory capacity, to support the performance of the job. Provisioning software manages and allocates virtual machines among the available servers within the cluster. Because each virtual machine runs independent of other virtual machines, multiple operating system environments can co-exist on the same computer in complete isolation from each other.

### BRIEF SUMMARY

One embodiment of the present invention provides a method, comprising identifying uptime for each of a plurality of physical servers within a cluster, scheduling jobs on the physical servers within the cluster giving priority to the use of physical servers in order of increasing uptime, and powering off physical servers within the cluster that have no assigned jobs. Scheduling jobs on servers with the least amount of uptime, allows the job scheduler to uniformly balance the uptime of the servers within the cluster so that the entire cluster of physical machines ages at the same rate.

Another embodiment of the present invention provides a computer program product including computer readable program code embodied on a computer readable storage medium. The computer program product comprises computer readable program code for identifying uptime for each of a plurality of physical servers within a cluster, computer readable program code for scheduling jobs on the physical servers within the cluster giving priority to the use of physical servers in order of increasing uptime; and computer readable program code for powering off physical servers within the cluster that have no assigned jobs. The computer program product that includes scheduling jobs on servers with the least amount of uptime, allows the computer program product to uniformly balance the uptime of the servers within the cluster so that the entire cluster of physical machines ages at the same rate.

### BRIEF DESCRIPTION OF THE SEVERAL VIEWS OF THE DRAWINGS

FIG. 1 depicts an exemplary computer that may be utilized by the presently disclosed method, system, and/or computer program product.

FIG. 2 illustrates an exemplary blade chassis that may be utilized by the presently disclosed method, system, and/or computer program product.

FIG. 3 depicts another embodiment of the present disclosed method utilizing multiple physical computers in a virtualized rack.

FIG. 4 is a diagram illustrating certain data maintained by a director server or a management node including a provisioning manager.

FIG. 5 is a block diagram of virtual machines running on two physical servers.

FIG. 6 is a diagram of a cluster of physical servers in communication with a system management node including a provisioning manager for scheduling jobs.

FIG. 7 is a flowchart of a method in accordance with one embodiment of the present invention.

### DETAILED DESCRIPTION

One embodiment of the present invention provides a method, comprising identifying uptime for each of a plurality of physical servers within a cluster, scheduling jobs on the physical servers within the cluster giving priority to the use of physical servers in order of increasing uptime, and powering off physical servers within the cluster that have no assigned jobs.

In one embodiment, each physical server stores uptime in vital product data accessible to a management controller of the physical server. Accordingly, the uptime for each of the plurality of physical servers within the cluster may be identified by reading the vital product data for each of the plurality of physical servers. In a preferred implementation, a management controller in each physical server, such as a baseboard management controller, reads the uptime from the stored vital product data and communicates the uptime to a cluster management node, which then communicates the uptime for each physical server to a workload manager that is responsible for scheduling jobs among the physical servers within the cluster. The workload manager may optionally store the uptime for each of the physical servers in the cluster in order to have that data available for workload management in accordance with embodiments of the present invention. The current uptime of each physical server should be periodically reported to the workload manager or optionally can be read by the workload manager from each physical server.

In another embodiment, the method may further include receiving an additional job request to be run by one of the physical servers within the cluster, identifying an available capacity of each of the plurality of physical servers within the cluster, and identifying a subset of the physical servers that each have sufficient available capacity to run the job. Accordingly, the step of scheduling jobs on the physical servers within the cluster giving priority to the use of physical servers in order of increasing uptime, may include scheduling the additional job on one of the physical servers, selected from among the subset of the physical servers, that has the least uptime.

In yet another embodiment, the method may further include determining a performance capacity that is needed to run the jobs, and identifying a first subset of the physical servers that collectively provide the determined performance capacity, wherein the physical servers in the first subset are selected giving priority to physical servers in order of increasing uptime. All of the jobs are then scheduled on the first subset of the physical servers.

In a still further embodiment, the method may further include powering on additional physical servers within the cluster in order of increasing uptime as needed to run the jobs. The powering on of additional physical servers in this manner may be beneficial during startup of the cluster following some amount of usage, or as there is an increase in the performance capacity needed by the jobs, or an increase in the actual number of jobs.

The step of scheduling jobs on the physical servers within the cluster giving priority to the use of physical servers in order of increasing uptime, may include sequentially scheduling all of the jobs, one job at a time, to be run by the physical server having the least uptime among the physical servers that have available capacity for the job.

In an additional embodiment, the method further comprises migrating all of the jobs from a first physical server within the cluster to one or more of the physical servers within the cluster having less uptime than the first physical server. Such a step provides only a marginal improvement in wear leveling. However, an alternative is to migrate all of the jobs from a first physical server within the cluster to at least one other physical server within the cluster, wherein the first physical server has the most uptime among the physical servers that are running. The latter alternative has the effect of stopping the wear on the physical server having the most uptime.

A system management node may monitor and track uptime for each of the physical servers or other components in the cluster. This uptime data is taken into account in the scheduling of workloads, system bring-up and power-down sequence. A workload scheduler may then control how the systems are utilized and can adjust usage of the physical servers or other components. A high performance computing cluster may have an ideal life cycle, such as 3 to 4 years, before the entire cluster is replaced with new generation technology (i.e., processors, DIMMs, interconnect, HDDs, etc). Therefore, embodiments of the present invention facilitate uniform wear and failure of the physical servers close to the end of the life cycle of the cluster rather than allowing the cluster to experience a wide range in physical server life. In other words, it is undesirable to experience early failure of some components or servers due to overuse even if balanced by longer life cycles on other components or servers due to less usage.

While the foregoing discussion focuses on physical servers, other components within the cluster, such as network switches and data storage devices, may also experience similarly wear leveling in accordance with the present invention. For example, the method may further include identifying uptime for additional components selected from network switches and data storage devices, and scheduling jobs on the physical servers within the cluster giving priority to the use of physical servers that use the additional components in order of increasing uptime. In other words, jobs may be scheduled on physical servers that use a first network switch that has less uptime than a second network switch in order to wear level the network switches. The additional components within the cluster that are used by physical servers that have no assigned jobs should be powered off.

Another embodiment of the present invention provides a computer program product including computer readable program code embodied on a computer readable storage medium. The computer program product comprises computer readable program code for identifying uptime for each of a plurality of physical servers within a cluster, computer readable program code for scheduling jobs on the physical servers within the cluster giving priority to the use of physical servers in order of increasing uptime; and computer readable program code for powering off physical servers within the cluster that have no assigned jobs.

The foregoing computer program products may further include computer readable program code for implementing or initiating any one or more aspects of the methods described herein. Accordingly, a separate description of the methods will not be duplicated in the context of a computer program product.

Embodiments of the present invention provide methods of scheduling jobs in a cluster environment with consideration for the wear level of physical components within the cluster. More specifically, the method may include balancing (wear-leveling) of the uptime, perhaps measured in power-on hours, across an entire cluster so that the entire cluster experiences wear together rather than randomly. Still further, the present invention may be used to manage a uniform life cycle for datacenter clusters by maintaining uniform usage of servers, switches, storage and sub-components and synchronizing uptime based on usage. The ability to manage wear level has several benefits in terms of warranty and cluster life cycle considerations.

It should be understood that although this disclosure is applicable to cloud computing, implementations of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

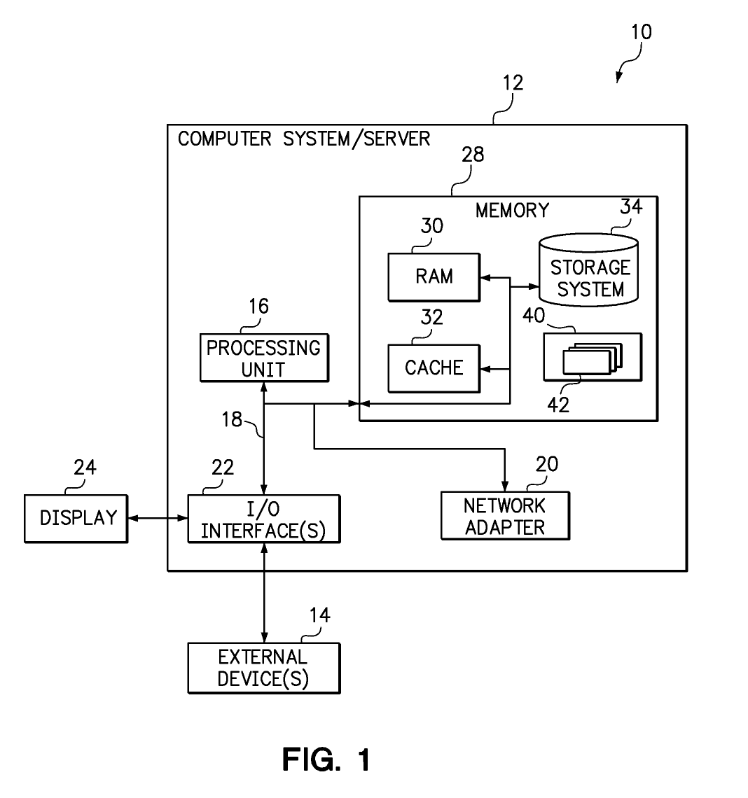

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

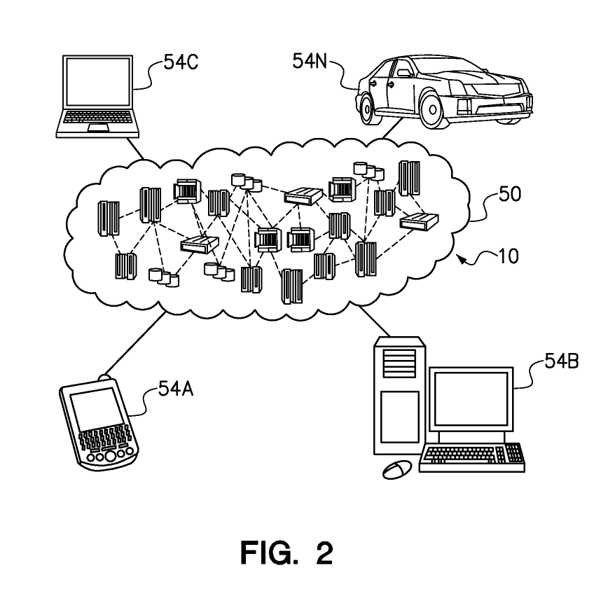

Referring now to FIG. 2, an illustrative cloud computing environment 50 is depicted. As shown, the cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

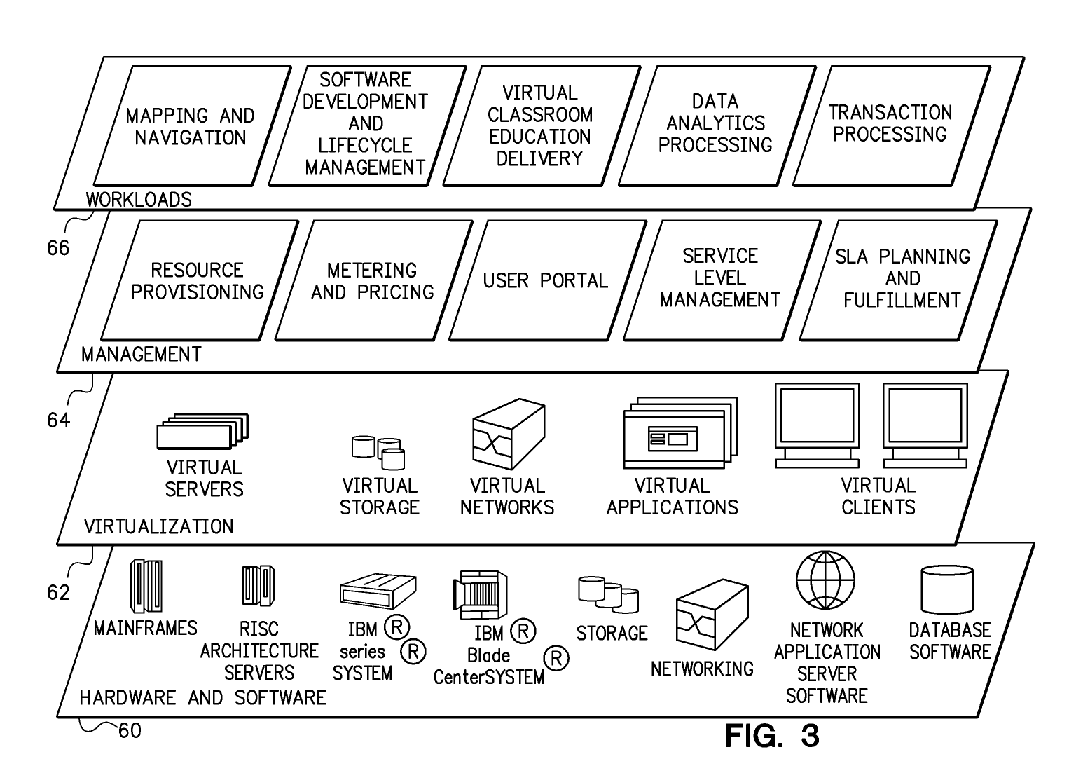

Referring now to FIG. 3, a set of functional abstraction layers provided by cloud computing environment 50 (Shown in FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

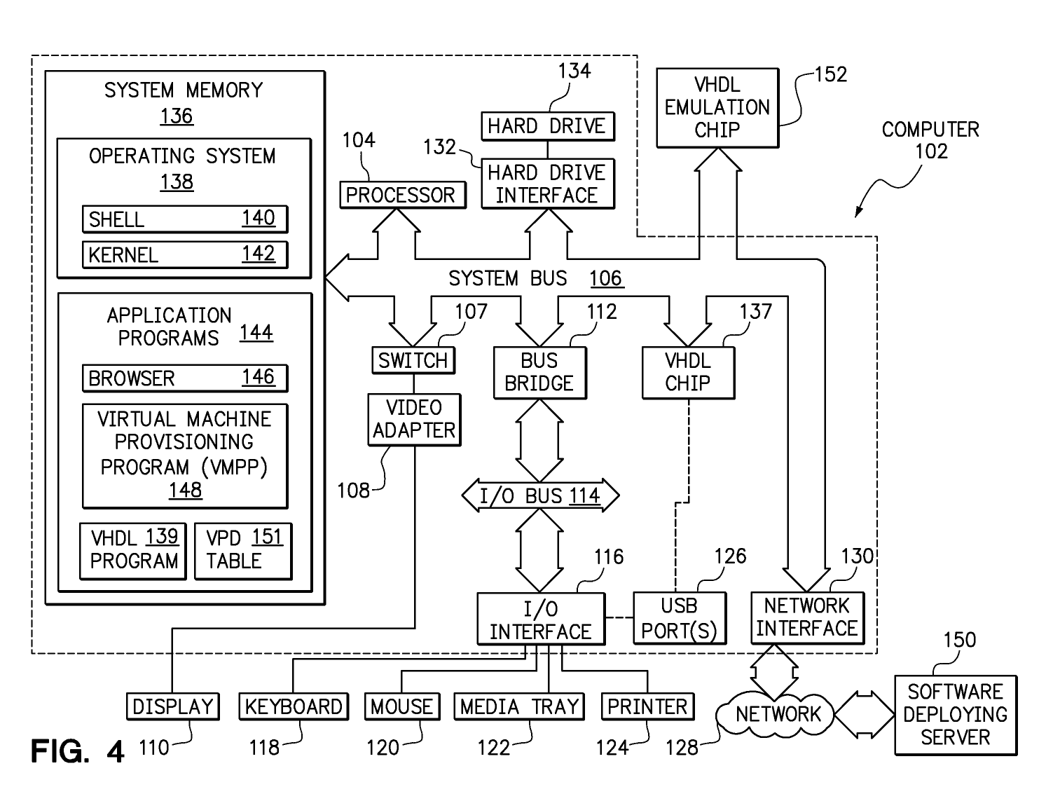

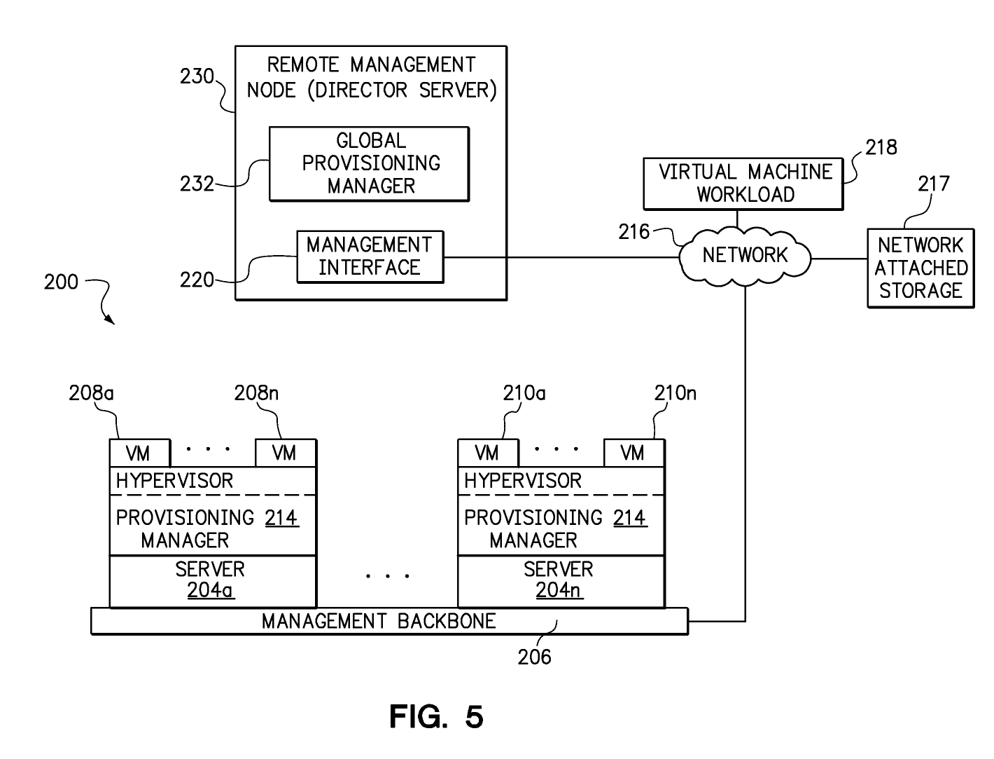

FIG. 4 depicts an exemplary computing node (or simply “computer”) 102 that may be utilized in accordance with one or more embodiments of the present invention. Note that some or all of the exemplary architecture, including both depicted hardware and software, shown for and within computer 102 may be utilized by the software deploying server 150, as well as the provisioning manager/management node 222 and the physical servers 204a-n shown in FIG. 5. Note that while the servers described in the present disclosure are described and depicted in exemplary manner as physically separate servers, they could also be server blades in a blade chassis, and some or all of the computers described herein may be stand-alone computers, servers, or other integrated or stand-alone computing devices. Thus, the terms “blade,” “server blade,” “computer,” “server” and “physical server” are used interchangeably in the present descriptions.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., virtual machine provisioning program—VMPP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, computer 102 is able to communicate with a software deploying server 150 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

Application programs 144 in the system memory of computer 102 (as well as the system memory of the software deploying server 150) also include a virtual machine provisioning program (VMPP) 148. VMPP 148 includes code for implementing the processes of the present invention. In one embodiment, the computer 102 is able to download VMPP 148 from software deploying server 150, including in an on-demand basis. Note further that, in one embodiment of the present invention, software deploying server 150 performs all of the functions associated with the present invention (including execution of VMPP 148), thus freeing computer 102 from having to use its own internal computing resources to execute VMPP 148.

Also stored in the system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from VMPP 148 causes the VHDL program 139 to configure the VHDL chip 137, which may be an FPGA, ASIC, or the like.

In another embodiment of the present invention, execution of instructions from VMPP 148 results in a utilization of VHDL program 139 to program a VHDL emulation chip 152. VHDL emulation chip 152 may incorporate a similar architecture as described above for VHDL chip 137. Once VMPP 148 and VHDL program 139 program VHDL emulation chip 152, VHDL emulation chip 152 performs, as hardware, some or all functions described by one or more executions of some or all of the instructions found in VMPP 148. That is, the VHDL emulation chip 152 is a hardware emulation of some or all of the software instructions found in VMPP 148. In one embodiment, VHDL emulation chip 152 is a programmable read only memory (PROM) that, once burned in accordance with instructions from VMPP 148 and VHDL program 139, is permanently transformed into a new circuitry that performs the functions needed to perform the processes of the present invention.

The hardware elements depicted in computer 102 are not intended to be exhaustive, but rather are representative. For instance, computer 102 may include alternate memory storage devices such as magnetic cassettes, digital versatile disks (DVDs), Bernoulli cartridges, and the like. These and other variations are intended to be within the spirit and scope of the present invention.

A cloud computing environment allows a user workload to be assigned a virtual machine (VM) somewhere in the computing cloud. Each virtual machine provides the software operating system and physical resources such as processing power and memory to support the user's application workload.

FIG. 5 depicts an exemplary cluster of servers that may be utilized in accordance with one or more embodiments of the present invention. The exemplary cluster 200 may operate in a “cloud” environment to provide a pool of resources. The cluster 200 comprises a plurality of servers 204a-n (where “a-n” indicates an integer number of servers) coupled to a management backbone 206. Each server supports one or more virtual machines (VMs). As known to those skilled in the art of computers, a VM is a software implementation (emulation) of a physical computer. A single hardware computer (blade) can support multiple VMs, each running the same, different, or shared operating systems. In one embodiment, each VM can be specifically tailored and reserved for executing software tasks 1) of a particular type (e.g., database management, graphics, word processing etc.); 2) for a particular user, subscriber, client, group or other entity; 3) at a particular time of day or day of week (e.g., at a permitted time of day or schedule); etc.

As depicted in FIG. 5, a server 204a supports VMs 208a-n (where “a-n” indicates an integer number of VMs), and a server 204n supports VMs 210a-n (wherein “a-n” indicates an integer number of VMs). The servers 204a-n include a hypervisor and provisioning manager 214, guest operating systems, and applications for users (not shown). Provisioning software can be located remotely in the network 216 and transmitted from the network attached storage 217 over the network. The global provisioning manager 232 running on the remote management node (Director Server) 230 performs this task. In this embodiment, the computer hardware characteristics are communicated from the VPD 151 to the VMPP 148. The VMPP 148 communicates the computer physical characteristics to the blade chassis provisioning manager 222, to the management interface 220, and to the global provisioning manager 232 running on the remote management node (Director Server) 230.

Note that the management backbone 206 is also coupled to the network 216, which may be a public network (e.g., the Internet), a private network (e.g., a virtual private network or an actual internal hardware network), etc. The network 216 permits a virtual machine workload 218 to be communicated to a management interface 220 of the remote management node 230. This virtual machine workload 218 is a software task whose execution, on any of the VMs within one of the servers 204, is to request and coordinate deployment of workload resources with the management interface 220. The management interface 220 then transmits this workload request to a hypervisor and provisioning manager 214, which is hardware and/or software logic capable of configuring VMs within the an individual server 204 to execute the requested software task. In essence the virtual machine workload 218 manages the overall provisioning of VMs by communicating with the management backbone 206 connected to each of the individual servers 204 a-n, provisioning each VM 208a-n and 210a-n using the servers internal provisioning manager 214 integrated with the hypervisor. Note that the server 204 is an exemplary computer environment in which the presently disclosed methods can operate. The scope of the presently disclosed system is not limited to a physical server or to a blade chassis, however. That is, the presently disclosed methods can also be used in any computer environment that utilizes some type of workload management or resource provisioning, as described herein.

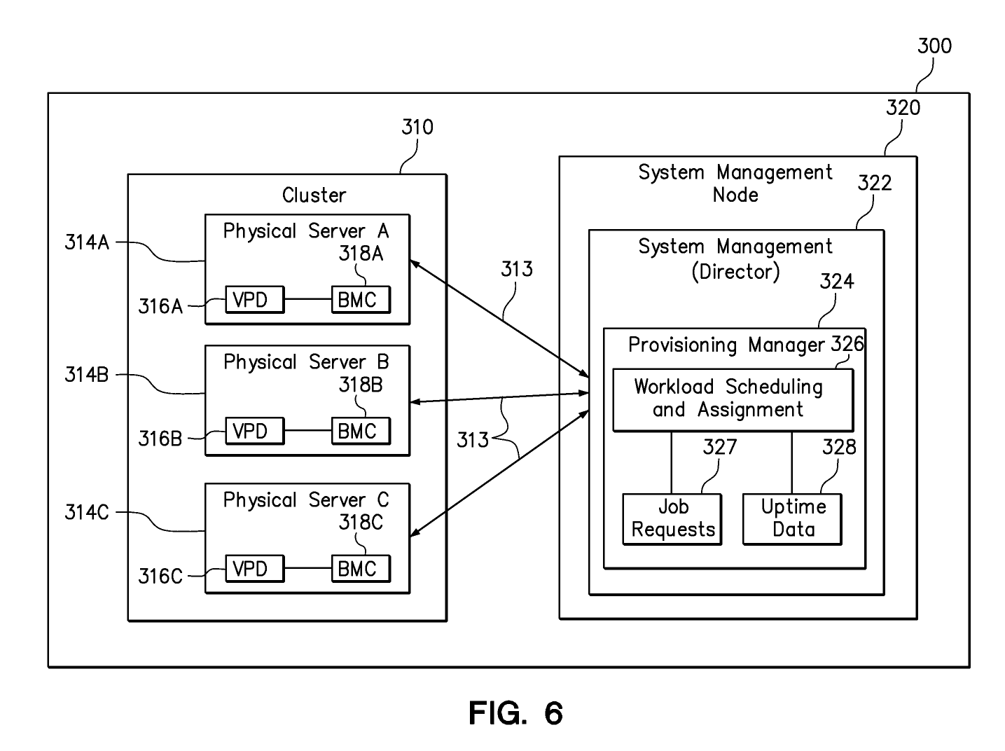

FIG. 6 is a diagram of a cluster 300 including a cluster 310 of physical servers 314A-C in communication with a system management node 320 running a system management software application 322 that includes a provisioning manager 324 for scheduling jobs. The provisioning manager 324 includes a workload scheduling and assignment module (a “scheduler”) 326 that performs the scheduling of the jobs within the cluster 310. The scheduler 326 has access to job requests 327 and uptime data 328. For example, the job requests 327 may include job characteristics, such as a measure of the amount of workload associated with running the job. Before scheduling a job on a particular physical server, the scheduler 326 may determine that the physical server has available capacity that is at least equal to the workload associated with the job.

The uptime data 328 enables the scheduler 326 to giving priority to the use of physical servers in order of increasing uptime. After collecting the uptime data from a management controller in each physical server, the scheduler will prioritize use of physical servers having a lower amount of uptime.

In this non-limiting example, the cluster 310 includes a physical server A 314A, a physical server B 314B, and a physical server C 314C. A typical implementation of a cluster may include many more servers. As shown, each of the physical servers has the same general construction and operation. For example, the physical server A 314A includes a baseboard management controller (BMC) 318A that is able to read the vital product data (VPD) 316A of the physical server A 314A. The VPD 316A preferably includes the amount of uptime for the physical server A. The BMC 318A may then communicate the uptime to the system management node 320, which provides the uptime data to the scheduler 326. The VPD will typically include additional information, such as the component type, component model number and component manufacturer. In accordance with various embodiments of the invention, the scheduler 326 compares the uptime for each of the physical servers. Optionally, the schedule may rank each of the physical servers in order of their amount of uptime, and then use the ranking to prioritize use of the physical servers in order of increasing uptime (i.e., schedule jobs on physical servers having lower uptime prior to scheduling jobs on physical servers having greater uptime). The uptime data 328 should be updated periodically. Furthermore, as each new job is submitted to the provisioning manager 324, the scheduler 326 allocates physical servers and schedules the new job on a physical server giving priority to the use of the physical servers in order of increasing uptime.

The uptime data 328 may be represented by Table 1 (below), which shows an amount of uptime (i.e., power on hours or “POH”) for each of the physical servers in a cluster. Each server is identified by a rack number and unit/location number, such that “R1-U1” identifies a physical server installed in Rack 1 at Unit 1. The uptime data in Table 1 shows a large range among physical server uptime. In this example, the mean physical server uptime within the cluster is 14,329 hours. The difference between the least used physical server (R2-U8; 6200 hours) and most used physical server (R1-U13; 22,900 hours) is 16,700 hours or 696 days (99 weeks). This 16,700 POH difference in uptime represents 38% of the overall warranty period of 43,800 hours (five years).

TABLE 1
Example of random server usage

| | POH | | POH | Warranty |
|---|---|---|---|---|
| R1-U1 | 8453 | R2-U1 | 6328 | 43800 |
| R1-U2 | 13980 | R2-U2 | 14542 | 43800 |
| R1-U3 | 14550 | R2-U3 | 16549 | 43800 |
| R1-U4 | 14345 | R2-U4 | 18455 | 43800 |
| R1-U5 | 11632 | R2-U5 | 12670 | 43800 |
| R1-U6 | 20100 | R2-U6 | 12550 | 43800 |
| R1-U7 | 15200 | R2-U7 | 15442 | 43800 |
| R1-U8 | 15550 | R2-U8 | 6200 | 43800 |
| • | • | • | • | • |
| • | • | • | • | • |
| • | • | • | • | • |
| R1-U12 | 13987 | R2-U12 | 8325 | 43800 |
| R1-U13 | 22900 | R2-U13 | 12100 | 43800 |
| R1-U14 | 19432 | R1-U14 | 17550 | 43800 |
| R1-U15 | 12453 | R2-U15 | 16350 | 43800 |
| R1-U16 | 9743 | R2-U16 | 14660 | 43800 |
| R1-U17 | 13990 | R2-U17 | 12280 | 43800 |
| R1-U18 | 12387 | R2-U18 | 20105 | 43800 |
| R1-U19 | 19443 | R2-U19 | 16280 | 43800 |
| • | • | • | • | • |
| • | • | • | • | • |
| • | • | • | • | • |

Embodiments of the present invention may be used to significantly reduce the range of uptime and get more service out of all the physical servers within the cluster. Continuing with the foregoing example of uptime data 328, Table 2 (below) shows how the wide range of uptime (POH) of the physical servers shown in Table 1 can be reduced by the methods of the present invention. Table 2 shows a mean physical server uptime time of 20,725. The difference in POH between the least used physical server (R2-U4; 18,625 POH) and the most used physical server (R1-U13; 22,900 POH) has been drastically reduced from 16,700 POH (see Table 1) to 4,275 POH or 178 days (or 25 weeks). This 4,275 POH difference and range in uptime represents just 10% of the overall warranty period of 43,800 hours (five years).

TABLE 2
Example of server usage in a wear-leveled cluster.

| | POH | | POH | Warranty |
|---|---|---|---|---|
| R1-U1 | 20600 | R2-U1 | 21140 | 43800 |
| R1-U2 | 22435 | R2-U2 | 21390 | 43800 |
| R1-U3 | 19245 | R2-U3 | 20450 | 43800 |
| R1-U4 | 19900 | R2-U4 | 18625 | 43800 |
| R1-U5 | 21500 | R2-U5 | 19543 | 43800 |
| R1-U6 | 19600 | R2-U6 | 21675 | 43800 |
| R1-U7 | 21200 | R2-U7 | 21238 | 43800 |
| R1-U8 | 20340 | R2-U8 | 19354 | 43800 |
| • | • | • | • | • |
| • | • | • | • | • |
| • | • | • | • | • |
| R1-U12 | 21100 | R2-U12 | 19240 | 43800 |
| R1-U13 | 22900 | R2-U13 | 21254 | 43800 |
| R1-U14 | 21432 | R2-U14 | 21647 | 43800 |
| R1-U15 | 21500 | R2-U15 | 21200 | 43800 |
| R1-U16 | 21450 | R2-U16 | 21654 | 43800 |
| R1-U17 | 19540 | R2-U17 | 19439 | 43800 |
| R1-U18 | 21600 | R2-U18 | 20105 | 43800 |
| R1-U19 | 19443 | R2-U19 | 21450 | 43800 |
| • | • | • | • | • |
| • | • | • | • | • |
| • | • | • | • | • |

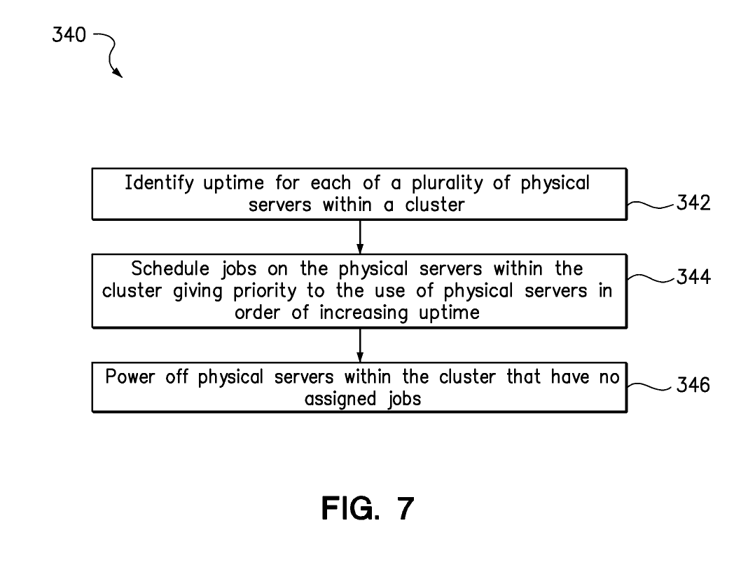

FIG. 7 is a flowchart of a method 340 in accordance with one embodiment of the present invention. In step 342, the method identifies uptime for each of a plurality of physical servers within a cluster. Step 344 schedules jobs on the physical servers within the cluster giving priority to the use of physical servers in order of increasing uptime. Then, in step 346, the physical servers within the cluster that have no assigned jobs are powered off. Since the jobs are scheduled on physical servers in order of increasing uptime (i.e., scheduling jobs first to physical servers having lower uptime, before scheduling jobs to physical servers having somewhat higher uptime), the physical servers within the cluster having the highest uptime may have no jobs and will be powered off. As a result, physical servers having low uptime relative to other physical servers within the cluster will tend to operate more so that their uptime increases, and physical servers having high uptime relative to other physical servers within the cluster will tend to operate less so that their uptime does not increase. Using the method over time will result in a narrowing range of uptime, which may be referred to as “wear leveling.”

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
identifying uptime for each of a plurality of physical servers within a cluster;
scheduling jobs on the physical servers within the cluster giving priority to the use of physical servers in order of increasing uptime; and
powering off physical servers within the cluster that have no assigned jobs.

2. The method of claim 1, further comprising:
identifying an available capacity of each of the plurality of physical servers within the cluster;
receiving an additional job request to be run by one of the physical servers within the cluster;
identifying a subset of the physical servers that each have sufficient available capacity to run the job;
wherein scheduling jobs on the physical servers within the cluster giving priority to the use of physical servers in order of increasing uptime, includes scheduling the additional job on one of the physical servers, from among the subset of the physical servers, that has the least uptime.

3. The method of claim 1, further comprising:
determining a performance capacity that is needed to run the jobs;
identifying a first subset of the physical servers that collectively provide the determined performance capacity, wherein the physical servers in the first subset are selected giving priority to physical servers in order of increasing uptime;
scheduling all of the jobs on the first subset of the physical servers.

4. The method of claim 1, further comprising:
powering on additional physical servers within the cluster in order of increasing uptime as needed to run the jobs.

5. The method of claim 1, wherein scheduling jobs on the physical servers within the cluster giving priority to the use of physical servers in order of increasing uptime, includes sequentially scheduling each job to be run by the physical server having the least uptime among the physical servers that have available capacity for the job.

6. The method of claim 1, further comprising:
migrating all of the jobs from a first physical server within the cluster to one or more of the physical servers within the cluster having less uptime than the first physical server.

7. The method of claim 1, further comprising:
migrating all of the jobs from a first physical server within the cluster to at least one other physical server within the cluster, wherein the first physical server has the most uptime among the physical servers that are running.

8. The method of claim 1, further comprising:
each physical server storing uptime in vital product data accessible to a management controller of the physical server.

9. The method of claim 8, wherein identifying uptime for each of the plurality of physical servers within the cluster, includes reading vital product data for each of the plurality of physical servers.

10. The method of claim 9, further comprising:
a management controller in each physical server reading the uptime from the stored vital product data and communicating the uptime to a cluster management node.

11. The method of claim 10, further comprising:
the cluster management node communicating the uptime for each physical server to a workload manager that is responsible for scheduling jobs among the physical servers within the cluster.

12. The method of claim 11, further comprising:
the workload manager storing the uptime for each of the physical servers in the cluster.

13. The method of claim 1, further comprising:
identifying uptime for additional components selected from network switches and data storage devices;
scheduling jobs on the physical servers within the cluster giving priority to the use of physical servers that use the additional components in order of increasing uptime; and
powering off the additional components within the cluster that are used by physical servers that have no assigned jobs.

14. A computer program product including computer readable program code embodied on a computer readable storage medium, the computer program product comprising:
computer readable program code for identifying uptime for each of a plurality of physical servers within a cluster;
computer readable program code for scheduling jobs on the physical servers within the cluster giving priority to the use of physical servers in order of increasing uptime; and
computer readable program code for powering off physical servers within the cluster that have no assigned jobs

15. The computer program product of claim 14, further comprising:
computer readable program code for identifying an available capacity of each of the plurality of physical servers within the cluster;
computer readable program code for receiving an additional job request to be run by one of the physical servers within the cluster;
computer readable program code for identifying a subset of the physical servers that each have sufficient available capacity to run the job;
wherein the computer readable program code for scheduling jobs on the physical servers within the cluster giving priority to the use of physical servers in order of increasing uptime, includes computer readable program code for scheduling the additional job on one of the physical servers, from among the subset of the physical servers, that has the least uptime.

16. The computer program product of claim 14, further comprising:
computer readable program code for determining a performance capacity that is needed to run the jobs;
computer readable program code for identifying a first subset of the physical servers that collectively provide the determined performance capacity, wherein the physical servers in the first subset are selected giving priority to physical servers in order of increasing uptime;
computer readable program code for scheduling all of the jobs on the first subset of the physical servers.

17. The computer program product of claim 14, further comprising:
computer readable program code for powering on additional physical servers within the cluster in order of increasing uptime as needed to run the jobs.

18. The computer program product of claim 14, wherein the computer readable program code for scheduling jobs on the physical servers within the cluster giving priority to the use of physical servers in order of increasing uptime, includes computer readable program code for sequentially scheduling each job to be run by the physical server having the least uptime among the physical servers that have available capacity for the job.

19. The computer program product of claim 14, further comprising:
computer readable program code for migrating all of the jobs from a first physical server within the cluster to one or more of the physical servers within the cluster having less uptime than the first physical server.

20. The computer program product of claim 14, further comprising:
computer readable program code for migrating all of the jobs from a first physical server within the cluster to at least one other physical server within the cluster, wherein the first physical server has the most uptime among the physical servers that are running.
